(19) United States
(12) Patent Application Publication
(10) Pub. No.: US 2007/0023460 A1
(43) Pub. Date: Feb. 1, 2007

(54) Liquid conveying bottle top

(75) Inventor: Judith Ochen Diehl, Grosse Ile, MI (US)

Correspondence Address: OLSZEWSKI & ASSOCIATES, PLC, 156 WEST LIBERTY STREET, PLYMOUTH, MI, 48170, US

(73) Assignee: Ochen Industries, LLC

(21) Appl. No.: 11/190,758

(22) Filed: Jul. 27, 2005

(51) Int. Cl. B67D 3/00

(52) U.S. Cl. 222/478

(57) ABSTRACT

A bottle top for use in controlling the flow of dispensing fluids from common bottles which includes a base cylinder with an inner and outer wall and being partially enclosed at one end by a top surface. The inner wall includes threading for engaging any number of common bottle types while the outer wall includes a plurality of protrusions to aid in the griping of the bottle top for placing the bottle top on a bottle. The top surface includes a channel for directing the flow of the fluid towards a dispensing surface that caps the channel and includes at least two flow controlling dispensing apertures. The top surface further includes at least one inlet aperture for permitting air to enter into the bottle thereby allowing smooth fluid dispensing from the dispensing apertures.

### BACKGROUND OF THE INVENTION

1. Field of the Invention

The subject of this invention relates to a liquid conveying bottle top and, more specifically, to a bottle top that may be placed on top of a common bottle of juice, soda, water, or similar commonly purchased beverage to aid in the conveyance of the chosen fluid to the end user.

2. Description of the Background Art

For certain individuals, drinking directly from a store bought beverage bottle can be difficult. This is particularly true of the extremely young or old and those with disabilities who have difficulty in controlling the flow and, therefore, the regulation of the dispensing liquid captured therein.

Currently, there are cups on the market, generically called “sipper cups,” that caregivers may use to dispense different beverages to the individuals. The sipper cups are commonly a two-piece design that requires one to have the proper container and proper lid to work together. This design has inherent disadvantages such as the container and lid must be made to work together and, therefore, using containers from one manufacturer and lids from another manufacturer together is often impossible, frustrating the caregiver. Additionally, as both the container and lid are required to work together, the caregiver must take both along whenever a beverage maybe required during traveling. If the travels are of sufficient length, several containers and lids are required to be brought along requiring much space to be taken up in a travel bag. Further, these designs are of a “spill proof” design which require the end user to apply a certain amount of effort in a sucking action to dispense the contents of the container.

Additionally, U.S. Pat. No. 6,112,926, issued to Fishman on Sep. 5, 2000, discloses a bottle top for use on common beverage bottles. This bottle top threads onto a bottle and includes a spout member centrally located in an asymmetrical pyramidal shape with a single slotted opening. However, this bottle top does not include a spout member, or channel, adjacent the threaded area for reducing the movement required of the bottle to dispense the liquid, multiple apertures for improving regulation of the liquid, and does not include an air inlet aperture for smoothing the regulation of the liquid as it exits the bottle.

Therefore, there is a need for a bottle top that is easily transportable and adapted to fit on common beverage bottles of all types that includes an offset channel which requires less movement to dispense the liquid for improved ease in dispensing of the liquid, multiple apertures for better control of liquid regulation, and an inlet aperture to allow air to enter the container to replace the dispensing liquid resulting in smooth flow of the liquid.

### SUMMARY OF THE INVENTION

The present invention provides a replacement bottle top for regulating the flow of a liquid from the bottle to the end user. The bottle top includes a base cylinder that has an inner surface with bottle engaging threads and an outer surface with a plurality of protrusions. The bottle engaging threads engage like threads on the bottle for securely fastening the bottle top. The protrusions are included for providing friction for the ease of securing the bottle top to the bottle. The base cylinder is capped by a top surface with the top surface having a channel adjacent to the base cylinder for directing the flow of the liquid toward a dispensing surface. The dispensing surface includes at least two dispensing apertures for controlling the flow of the fluid. The top surface further includes at least one inlet aperture for allowing air to enter the bottle replacing the fluid as it exits the bottle thereby creating a smooth flow of liquid to the user.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is an isometric view of the bottle top;

FIG. 2 is a cross-sectional side view of the bottle top; and

FIG. 3 is an illustration of the bottle top in use.

### DETAILED DESCRIPTION OF THE PREFERRED EMBODIMENT

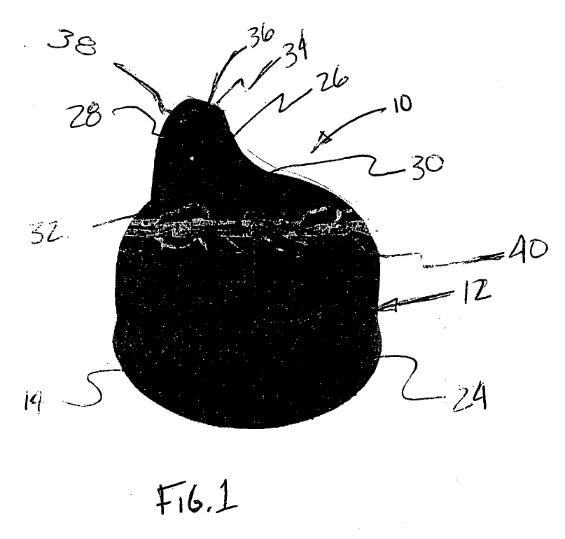

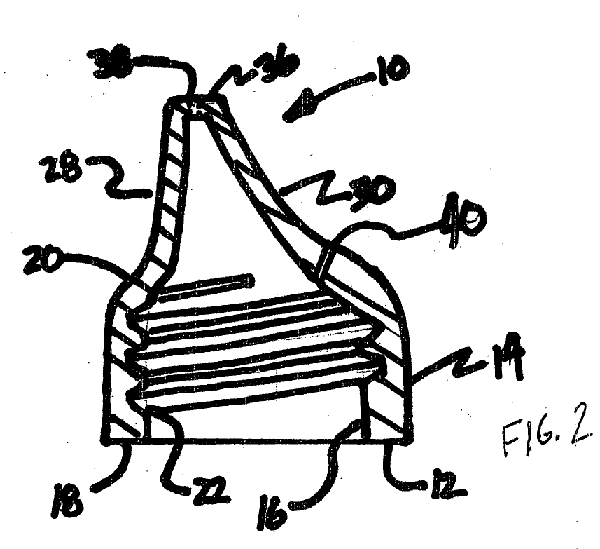

Referring to FIG. 1, a bottle top is generally shown at 10 for use on a common type beverage bottle, such as, but not limited to, blow molded plastic bottles or glass juice bottles. Referring now to FIG. 2, the bottle top 10 comprises a base cylinder 12 which is defined by an outer surface 14 and an inner surface 16 that extends from a first edge 18 to a distal top surface 20. The inner surface 16 includes threads 22 for mating engagement with any number of standard bottle threads. Referring to FIG. 1, the outer surface 14 includes a series of friction inducing protrusions 24, such as generally vertical ribs, for inducing friction to aid the addition or removal of the bottle top 10 to a bottle.

The top surface 20 includes a channel 26 that is located adjacent to the base cylinder 12 and extends upwardly from the top surface 20 for channeling the liquid flow. The channel 26 includes a generally vertical base wall 28, adjacent to the base cylinder 12, and an angled guiding wall 30 that are spaced apart and interconnected by a first side wall 32, a second side wall 34 and a dispensing surface 36. Referring to FIG. 2, the base wall 28 is generally vertical but may include a slight curvature or offset due to manufacturability, comfort and use concerns. The guiding wall 30 is arcuate as it extends from the top surface 20 and becomes closer to vertical as the guiding wall 30 approaches and connects to the dispensing surface 36. Referring to FIG. 1, the dispensing surface 36 not only interconnects the base wall 28, guiding wall 30, inner side wall 32 and outer side wall 34, it also includes at least two dispensing apertures 38 for allowing the liquid to flow from the bottle in a controlled manner.

The top surface 20 further includes at least one inlet aperture 40. The inlet aperture 40 allows for air to enter into the bottle while the liquid is being dispensed through the dispensing apertures 38. Alternatively, the inlet aperture 40 may be placed elsewhere on the bottle cap 10, such as the guiding wall 30, as required to facilitate the proper airflow into the bottle.

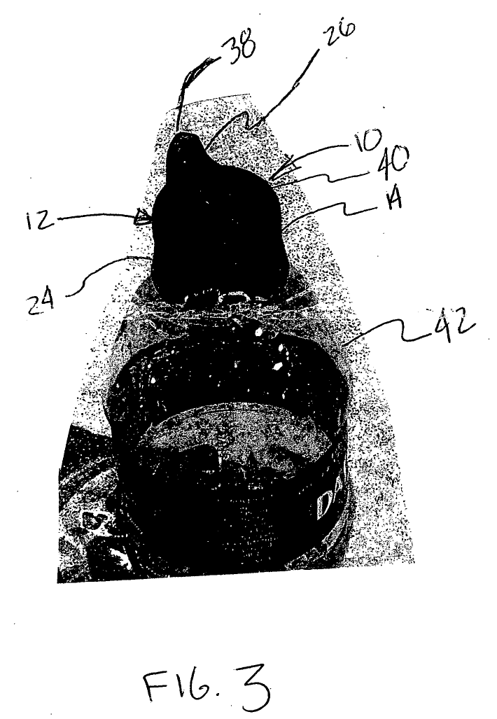

In operation and referring to FIG. 3, a beverage bottle 42 exists that the user wishes to control the flow of the liquid being dispensed. The user removes the cap the bottle came with and disposes of it. The user grips the bottle top 10 around the outer surface 14 of the base cylinder 12 and, being aided by the friction inducing protrusions 24, twists the bottle top 10 onto the bottle 42 and secures it thereto. The bottle may now be tipped so that the liquid flows into the channel 26 and exits the bottle top 10 through the dispensing apertures 38. While the liquid exits the bottle top 10, the volume of the liquid exiting is replaced with air through the inlet aperture 40 so that an even, regulated flow may be maintained.

The invention has been described in an illustrative manner, and it is to be understood that the terminology, which has been used, is intended to be in the nature of words of description rather than of limitation.

Many modification and variations of the present invention are possible in light of the above teachings. It is, therefore, to be understood that within the scope of the appended claims, the invention may be practiced other than as specifically described.

What is claimed is:

1. A bottle top for use in regulating the flow of a liquid comprising:
a base cylinder having an inner surface, an outer surface and top surface wherein said inner surface includes common bottle engaging threads, said outer surface includes a plurality of protrusions, and said top surface partially encloses said base cylinder at one end;
a channel extending from said top surface adjacent to said base cylinder comprising a base wall, a guiding wall, an inner side wall and an outer side wall each of which extend to and are interconnected and spaced apart by a dispensing surface;
at least two dispensing apertures on said dispensing surface.

2. A bottle top as set forth in claim 1 wherein said top surface includes an inlet aperture.

3. A bottle top as set forth in claim 1 wherein said channel includes an inlet aperture.
